(19) United States
(12) Patent Application Publication
(10) Pub. No.: US 2008/0195420 A1
(43) Pub. Date: Aug. 14, 2008

(54) METHOD, COMPUTER PROGRAM PRODUCT AND APPARATUS FOR GENERATING INTEGRATED ELECTRONIC HEALTH RECORDS

(76) Inventors: Harley Ramelson, Sharon, MA (US); Megan Callahan, San Mateo, CA (US); Kevin Ferriter, Beverly, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/673,184

(22) Filed: Feb. 9, 2007

(51) Int. Cl. G06F 19/00

(52) U.S. Cl. 705/3

(57) ABSTRACT

A method, computer program product, and apparatus for generating an integrated electronic health record. The integrated electronic health record provides an aggregate of health information across multiple data sources, including combining claims data with disease management data into a common electronic health record. By combining these data sources, an integrated electronic health record is generated that includes data that is not currently available at the point of care. As a result, the integrated health record may aid in the avoidance of medical errors, accelerate knowledge diffusion, and allow more patients to receive the latest evidence-based treatment.

### FIELD OF THE INVENTION

In general, embodiments of the present invention relate to electronic health records, and, in particular, to integrated electronic health records.

### BACKGROUND OF THE INVENTION

The U.S. healthcare system is considered by many to have various problems, such as rising costs, inconsistent quality, avoidable medical errors, and poor safety records to name a few. It has been reported that per capita health spending increased 39 percent between 1999 and 2003 for privately insured people, while worker's average hourly earnings grew only 14 percent. Some employers have reacted by beginning to eliminate healthcare benefits completely or shift more of the costs to employees. In addition to the problem of rising healthcare costs, many healthcare procedures still rely on dated information systems and paper-based records. Paper-based records are often susceptible to being lost, misfiled, damaged, or destroyed, leaving no record of the information contained therein. It has been reported that approximately 20 percent of medical tests require re-ordering simply because previous results were not available.

Utilizing the latest and most accurate information is critical in providing optimal healthcare for patients. Yet current procedures and practices do not adequately rely on such information. It has been reported that under standard customs, it takes approximately 17 years to translate scientific evidence into practice. Additionally, other reports indicate that current patients do not routinely receive “evidence-based” care, which can be defined as the use of current best evidence, such as external clinical evidence from systematic research, in making decisions about the care of individual patients. And when considering the prospects of bioterrorism, sharing the latest healthcare information is of utmost importance. An advanced health information infrastructure may enable public health organizations to respond more rapidly through large-scale inoculation campaigns and ongoing monitoring, detection, and treatment of complications arising from exposure to biochemical agents.

The problem is not that healthcare information does not translate well to electronic form. In fact, many healthcare entities are beginning to more fully utilize computer-based systems to accumulate and manage their records, and the latest medical studies and reports are becoming more commonly available in electronic form. The problem exists in integrating multiple data sources into a product that contains useful and accurate information for the user, be it a healthcare provider, payor, patient, etc.

As a result, there is a need for a method and apparatus for generating an electronic health record that contains healthcare information pertaining to one or more patients. The health record should be an aggregate of health information across multiple data sources that generates an integrated electronic health record. The integrated health record should be flexible, allowing various configurations for a variety of user applications, and should incorporate data sources that are not currently available at the point of care. The sources should be accurate, and should provide the most recent data available, thus aiding in the avoidance of medical errors, accelerating knowledge diffusion, and allowing more patients to receive the latest evidence-based treatment.

### BRIEF SUMMARY OF THE INVENTION

Exemplary embodiments of the present invention provide an improvement over the known prior art by, among other things, providing an integrated electronic health record that aggregates information from multiple data sources and interprets the data to populate a common electronic health record. In various embodiments, the integrated electronic health record may be accessible through a web browser or other user interface. In one embodiment, the present invention provides a method of generating an integrated health record comprising receiving claims data and disease management data, wherein receiving claims data comprises receiving claims data selected from the group consisting of medical claims data and pharmacy claims data, processing the claims data and the disease management data, wherein processing the claims data and the disease management data comprises associating the claims data and the disease management data, populating a common electronic health record with the claims data and disease management data, and displaying the common electronic health record in at least one clinical view, wherein displaying the common electronic health record in at least one clinical view comprises presenting at least a portion of the claims data or disease management data in an interactive form. In another embodiment, at least one detailed view may be associated with the clinical view. In another embodiment, the at least one clinical view may be selected from the group consisting of a patient information view, a summary page view, a conditions view, a procedures view, a tests view, an encounters view, an episodes view, a medications view, and a care management view. In another embodiment, at least one clinical view may be a conditions view, and at least one detailed view may be associated with the conditions view, the at least one detailed view combining claims data related to a given condition and presenting services associated with that condition, the conditions detailed view also being configured to allow grouping by a rank of diagnoses. In another embodiment, at least one clinical view is an episodes view, and wherein at least one detailed view may be associated with the episodes view, the at least one detailed view providing summary data obtained from claims data for a given episode. In another embodiment, the summary data is selected from the group consisting of data relating to conditions associated with the given episode, procedures associated with the given episode, tests associated with the given episode, encounters associated with the given episode, medications associated with the given episode, and disease management data associated with the given episode. In another embodiment, at least one clinical view is a medications view, and wherein at least one detailed view may be associated with the medications view, the at least one detailed view configured to allow a user to view prescriptions that were filled for a given medication. In another embodiment, the medications view may comprise at least one therapeutic class categorization for the given medication. In another embodiment, the medications view is configured to provide a link to a payor's formulary. In another embodiment, the clinical view is configured to select and aggregate diagnoses into a summary. In another embodiment, the at least one clinical view is configured to detail services for a specific condition, the services selected from the group consisting of encounters, procedures, lab tests, and diagnostic tests. In another embodiment, the at least one clinical view may be configured to separate services into procedures, lab tests, diagnostic tests, and encounters. In another embodiment, the at least one clinical view may be configured to categorize lab tests, diagnostic tests, and encounters. In another embodiment, the at least one clinical view may be configured to aggregate claims data at a medication level.

In another embodiment, displaying the common electronic health record further comprises displaying a customized clinical view including presenting at least a portion of the claims data or disease management data in a customized form. In another embodiment, displaying of the common electronic health record in at least one clinical view comprises applying a series of rules to the claims data and the disease management data to determine which portions of the claims data and the disease management data to display in the clinical view. Applying the series of rules may comprise grouping the claims data and the disease management data into categories. In another embodiment, grouping the claims data and the disease management data into categories may comprise determining if the claims data or the disease management data contains sensitive data, and if so, grouping sensitive claims data and sensitive disease management data into one or more categories containing sensitive data. In another embodiment, displaying a clinical view comprises requiring a predefined security authorization prior to including the sensitive data in the clinical view

In addition to the exemplary embodiments relating to methods of generating an integrated health record, the present invention also provides exemplary embodiments relating to computer program products and apparatuses for generating an integrated electronic health record, as described below.

In other embodiments, the present invention provides a method of providing a collaborative medical management environment among two or more users incorporating integrated electronic medical records. In one embodiment, the method comprises providing at least one integrated electronic health record, the integrated electronic health record comprising an aggregation of claims data and disease management data, providing users with access to the integrated electronic health records, and providing two-way communication among the users, allowing sharing of information among the users. In another embodiment, the users are selected from the group consisting of provider users, care manager users, and patient users. In another embodiment, the integrated electronic health record includes at least a care management clinical view comprising a patient care plan that includes a problem list, and wherein the sharing of information comprises one or more provider users reviewing care plan problems. In another embodiment, reviewing care plan problems is selected from the group consisting of indicating agreement or disagreement with one or more care plan problems, prioritizing one or more of the care plan problems, adding a comment to one or more of the care plan problems, and adding one or more new care plan problems. In another embodiment, at least one of a message or an alert is sent to one or more care manager users, the message containing information that a change to the care plan has been made by a provider user.

The integrated electronic health record of embodiments of the present invention provides an aggregate of health information across multiple data sources in a common electronic health record. Advantageously, this common electronic health record is able to supply healthcare providers with a patient's health information not currently available at the point of care. The integrated health record of embodiments of the present invention provides the most recent data, thus aiding in the avoidance of medical errors, accelerating knowledge diffusion, and allowing more patients to receive the latest evidence-based treatment. The integrated health record of the present invention is also flexible, allowing various clinical views for a variety of user applications.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic representation of an integrated electronic health record in accordance with one exemplary embodiment of the present invention;

FIG. 2 is a flow chart illustrating a method of generating an integrated health record in accordance with one exemplary embodiment of the present invention;

FIG. 3 shows an example of a login page generated by a computer program product in accordance with one embodiment of the present invention;

FIG. 4 shows an example of a search page generated by a computer program product in accordance with one embodiment of the present invention;

FIG. 5 shows an example of search results generated by a computer program product in accordance with one embodiment of the present invention;

FIG. 6 is a diagram showing various clinical views of an integrated electronic health record in accordance with one embodiment of the present invention;

FIG. 7 shows an example of a patient information view generated by a computer program product in accordance with one embodiment of the present invention;

FIG. 8 shows an example of a summary page view generated by a computer program product in accordance with one embodiment of the present invention;

FIG. 9 shows an example of a conditions view generated by a computer program product in accordance with one embodiment of the present invention;

FIG. 9A shows an example of a conditions detailed view generated by a computer program product in accordance with one embodiment of the present invention;

FIG. 10 shows an example of a procedures view generated by a computer program product in accordance with one embodiment of the present invention;

FIG. 11 shows an example of a tests view generated by a computer program product in accordance with one embodiment of the present invention;

FIG. 12 shows an example of an encounters view generated by a computer program product in accordance with one embodiment of the present invention;

FIG. 13 shows an example of an episodes view generated by a computer program product in accordance with one embodiment of the present invention;

FIG. 13A shows an example of an episodes detailed view generated by a computer program product in accordance with one embodiment of the present invention;

FIG. 14 shows an example of a medications view generated by a computer program product in accordance with one embodiment of the present invention;

FIG. 14A shows an example of a medications detailed view generated by a computer program product in accordance with one embodiment of the present invention;

FIG. 15 shows an example of a care management view generated by a computer program product in accordance with one embodiment of the present invention;

FIG. 16 is a block diagram of an exemplary electronic device configured to execute the integrated electronic health record application of exemplary embodiments of the present invention; and

FIG. 17 is a block diagram showing a collaborative environment among exemplary users incorporating integrated electronic health records in accordance with one embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

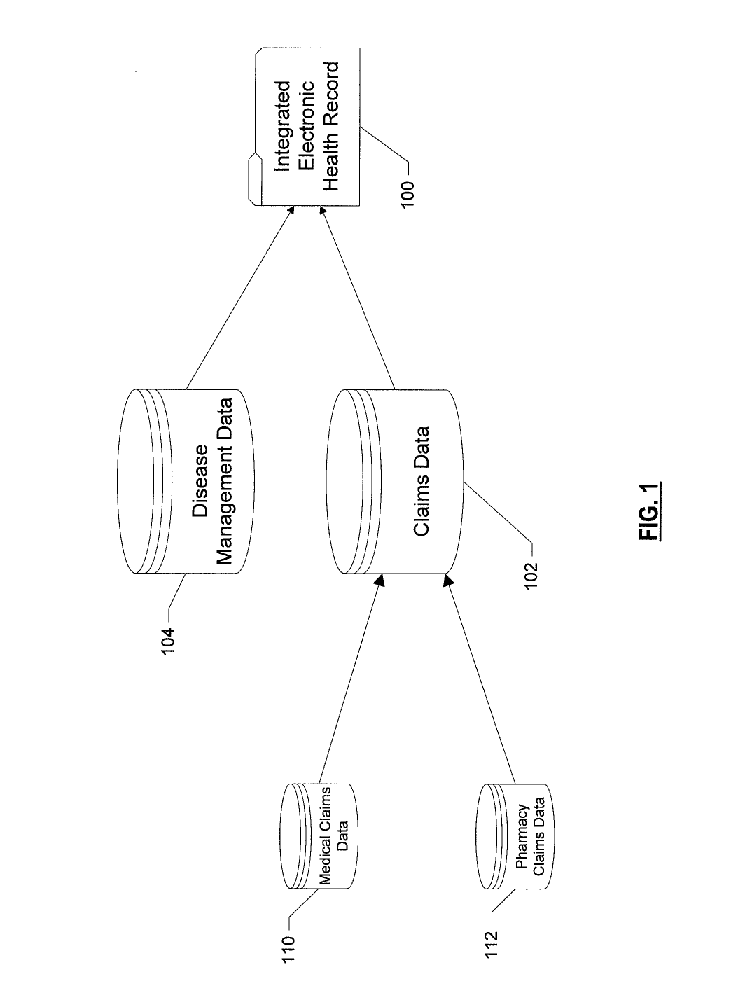

Embodiments of the present invention provide a method, a computer program product, and an apparatus for generating an integrated electronic health record that is an aggregate of health information across multiple data sources. In various embodiments, users may include, but are not limited to, healthcare providers (and/or healthcare provider staff), patients, payors (i.e. healthcare plans) (and/or payor staff), heath plan care managers, etc. An exemplary embodiment is shown in FIG. 1. An integrated electronic health record 100 (also hereinafter referred to as an “IEHR”) is generated by aggregating claims data 102, with disease management data 104. For the purposes of the current specification and appended claims, the term “claims data” is defined in its broadest sense and may refer to any type, form, or subject matter of information and/or data that concerns, either directly or indirectly, insurance claims filed by, or on behalf of, a patient or a group of patients. Claims data may include, but is not limited to, data from demands for payment for medical services performed or prescriptions dispensed. Claims data is not typically available to some users, such as healthcare providers. Standard electronic medical records usually have data specific to a particular provider, such as data that has been manually entered by a physician/practitioner or his/her staff. In various embodiments of the present invention, the information in claims data comes from multiple care settings and crosses the traditional electronic medical record boundaries defined by the walls of the practice. With this information, physicians/practitioners and other providers of care, can get a more complete picture of the patient's diagnoses, procedures, tests, medications and encounters. In various embodiments, the data in the integrated electronic health record may be received in a variety of ways including, but not limited to, automatic data loads and/or manual or direct data entry. In one embodiment, claims data is loaded covering a large period of time, for example 18-36 months. In other embodiments, however, portions of claims data may be incrementally updated, therein supporting real time (or near-real time) availability of the claims data. In such embodiments, certain rules may determine whether to incrementally update the claims data, including, but not limited to, if there are previously received related claims. In other embodiments, there may be a combination of large data loads with periodic incremental updates.

For the purposes of the current specification and appended claims, the term “disease management” is defined in its broadest sense and may refer to a system of coordinated healthcare interventions and/or communications directed toward patient conditions or wellness efforts. Disease management may also include care management, case management, or any other system producing a care plan, that may include problems, goals, and/or interventions. Disease management may support physician/practitioner - patient relationships and plans of care, emphasize prevention of exacerbations and complications utilizing evidence-based practice guidelines and patient empowerment strategies, and evaluate clinical, humanistic, and economic outcomes on an ongoing basis with a goal of improving the overall health of patients. The term “disease management data” is defined in its broadest sense and may refer to any type, form, or subject matter of information and/or data that concerns, either directly or indirectly, disease management. The data may be patient specific, specific to a group of patients, specific to a particular disease, specific to a group of diseases, or it may be generic. Examples of disease management data include, but are not limited to, a problem list showing the names of the problems associated with the patient, descriptions of the problems, and notes relating to the problems. The disease management data may also include barriers to care, comorbidities, self reported laboratory work, and other disease management information, including evidence-based medicine, medical literature, analytic and predictive modeling tools, treatment algorithms, a specific patient's prior test results, a specific patient's historical healthcare data, risk stratification, etc.

In the depicted exemplary embodiment of FIG. 1, the claims data 102 comprises medical claims data 110 and pharmacy claims data 112. Examples of medical claims data 110 and pharmacy claims data 112 include, but are not limited to, information relating to demands for payments from insurance claims based on medical services performed, and information relating to demands for payments from insurance claims based on prescriptions dispensed, respectively. Although not shown in FIG. 1, the IEHR of the depicted embodiment also includes member data and provider data. In various embodiments, member data and/or provider data may be received in addition to the claims data and the disease management data. In other embodiments, member data and/or provider data may be received with the claims data and/or the disease management data. In still other embodiments, member data and/or provider data may also be manually entered. Examples of member data include, but are not limited to, information as to the persons who are, or have been, covered under a health plan, including demographic information and information regarding a patient's eligibility for healthcare services. Examples of member data also include clinical data associated with a member which includes, but is not limited to, lab results, clinical results, clinical reports, clinical values, and self-reported data. Examples of provider data include, but are not limited to, information as to those entities that provide services for a member, including information such as address and phone number information and specialty and affiliation information regarding physicians, pharmacies, hospitals, etc.

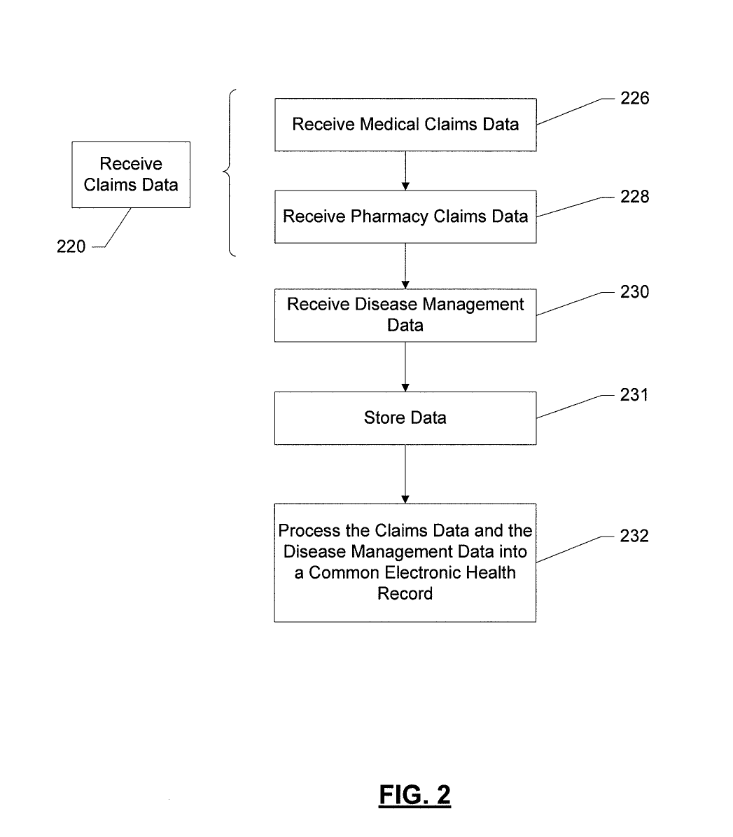

FIG. 2 shows a flow chart illustrating the steps which may be taken in order to implement a method of generating an IEHR 100 in accordance with one exemplary embodiment of the present invention. Steps 226-228 comprise the step of receiving claims data 220. Specifically, step 220 comprises receiving medical claims data 226 and receiving pharmacy claims data 228. It should be noted that FIG. 2 is meant to show a general method of generating an IEHR 100 and thus no weight should be given to the order in which any of the steps are presented.

After receiving the claims data and the disease management data, the method includes the step of storing the data 231. In the depicted embodiment, the data is permanently stored in a centralized manner, such as being stored on one or more central servers. Centralized servers may allow multiple clients to operate on the same platform. In other embodiments, however, the data may be stored locally. In still other embodiments, the data may be temporarily stored, either locally or centrally. In step 232, the method includes processing the claims data and the disease management data into a common electronic health record. Processing the claims data and the disease management data may comprise associating the claims data and the disease management data. Processing the claims data and the disease management data may also comprise applying a series of rules to the claims data and the disease management data. Applying the series of rules may comprise grouping the claims data and the disease management data into categories. Applying the series of rules may also determine which portions of the claims data and the disease management data to display in a clinical view. For the purposes of the current specification and the appended claims, the term “clinical view” is defined in its broadest sense and may refer to the presentation of the claims data and/or the disease management data, or a portion of the claims data and/or the disease management data, in any manner and/or form. Examples include, but are not limited to, various pages of a navigable/linkable computer program product. Processing the data may include aggregating the claims data and the disease management data into clinically meaningful clinical views and/or categorizing the aggregate claims data and disease management data in clinically meaningful ways. Thus, in various embodiments, this data, which is not typically available to a user, may be presented in a new and useful manner. For example, diagnoses may be selected and aggregated into a summary list. Clinical views may include all services performed for a specific condition across all types and dates of service. Services may be separated into encounters, procedures, lab tests, diagnostic tests, and the like. Encounters, procedures, lab tests, and diagnostic tests may be categorized into additional categories that are clinically meaningful. And information about a patient's prescriptions may be aggregated at the medication level. The data may be used to populate a common electronic health record. In various embodiments, populating may comprise including new data and/or updating data. The record may then be displayed in at least clinical view comprising presenting at least a portion of the claims data or the disease management data in an interactive form. The aggregated claims data and disease management data, or a portion of the claims data and/or the disease management data may also be presented in customizable clinical views based on a user's needs.

It should be noted that in various exemplary embodiments, the claims data and/or the disease management data may include “sensitive data.” For the purposes of the current specification and appended claims, the term “sensitive data” is defined as any data where there may be a desire to control access to said data in a clinical view or otherwise. Embodiments of the present invention provide the ability to define different groupings of sensitive codes, which may span code types. Code types may include, for example, certain ICD codes relating to diagnosis information, CPT codes relating to procedure information, codes relating to medications and/or SNOMED codes, etc. Code types may also include future codes and customized codes defined by users. Embodiments of the present invention provide for the ability to define one or more codes, regardless of code type, that may include sensitive data. For example, grouping the claims data and the disease management data may comprise determining if the claims data or the disease management data contains sensitive data, and if so, grouping sensitive claims data and sensitive disease management data into a category containing sensitive data. As will be discussed below, the rules applied to the data may restrict display of certain sensitive claims data and sensitive disease management data in a clinical view depending on whether a certain security authorization is exhibited by a user. If a certain security authorization is exhibited, the sensitive data may be displayed in the clinical view.

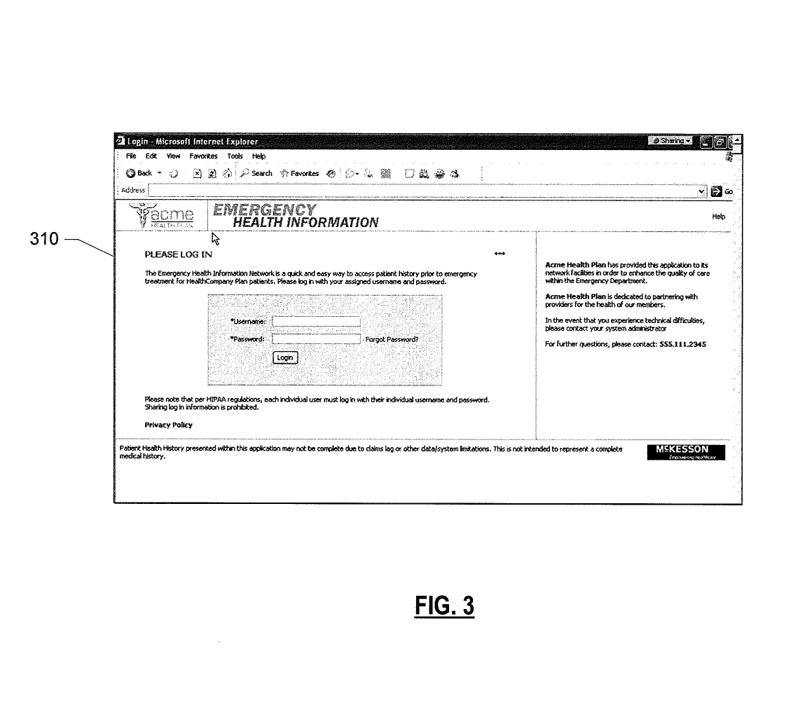

The following description relates to one exemplary embodiment of the present invention in which a patient's IEHR is available to a user at a point of care location, such as, for example, an emergency room located at a hospital using a web-based computer program product in accordance with one embodiment of the present invention. In various embodiments there may be one user or many users. Many users may access the IEHR, or several IEHRs one at a time or, in many cases, concurrently. In the exemplary embodiment, a patient's IEHR is accessible to a user through a web browser or alternatively, through an embedded portlet in a portal. As shown in FIG. 3, in the exemplary embodiment, a patient's IEHR may be accessed through a login page 310. The login page 310 may include a user organization's logo, if applicable, and may also include customized login instructions, if desired. The login page may also include the ability to enter a username and a password, as shown in the figure. The username and password may be authenticated using known methods to provide authorized user access to a patient's IEHR. Answers to security questions may also be collected upon initially logging in so that security questions may be used if a user forgets the user's password. The login page may also include customized disclaimers and/or other information as desired by a particular user.

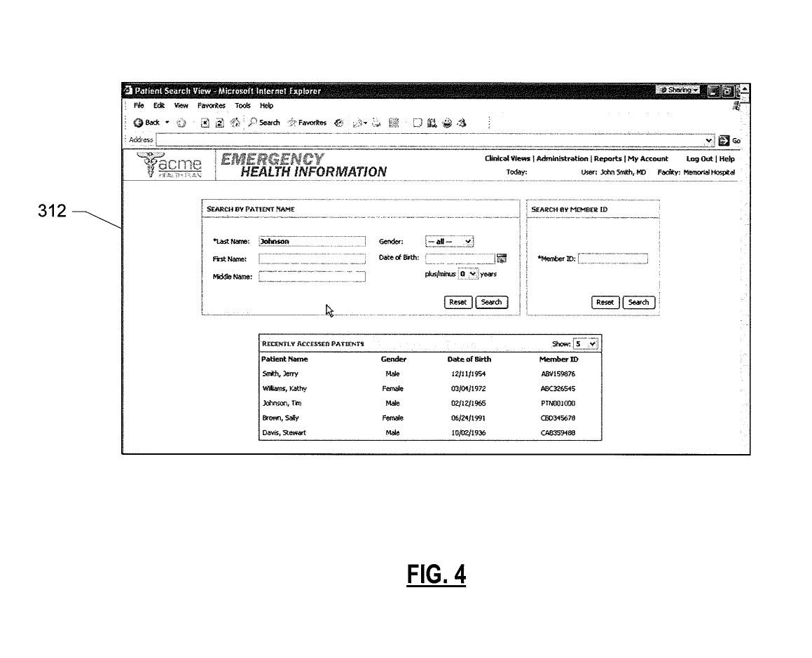

The IEHRs of the exemplary embodiment are categorized in a database by patient, and thus a user may perform a “patient search” in order to search for data relating to a particular patient. A user may search for a patient in a variety of ways. For example, a user may search for a particular patient using any one, or a combination of, the patient's last name, the patient's first name, the patient's middle name, the patient's date of birth, and the patient's gender. This information may be entered partially or in full. A search may also be performed using various identifiers associated with a particular patient. An example of a search page 312 generated by a computer program product in accordance with one embodiment of the present invention is shown in FIG. 4. Although the identifiers chosen to be used by a particular user may vary depending on the needs of the user, examples include member identification numbers, patient identification numbers, and social security numbers. A particular patient may also be searched using a list of the IEHRs last accessed by a particular user or a group of users, as shown in the figure. It should be noted that particular data associated with patients shown in the figures is intended to be fictional and thus any relation to real persons, living or dead, is purely coincidental. Additionally, although certain dates and date ranges shown in the figures are represented by shaded areas, an IEHR in accordance with the present invention would include actual dates and/or date ranges.

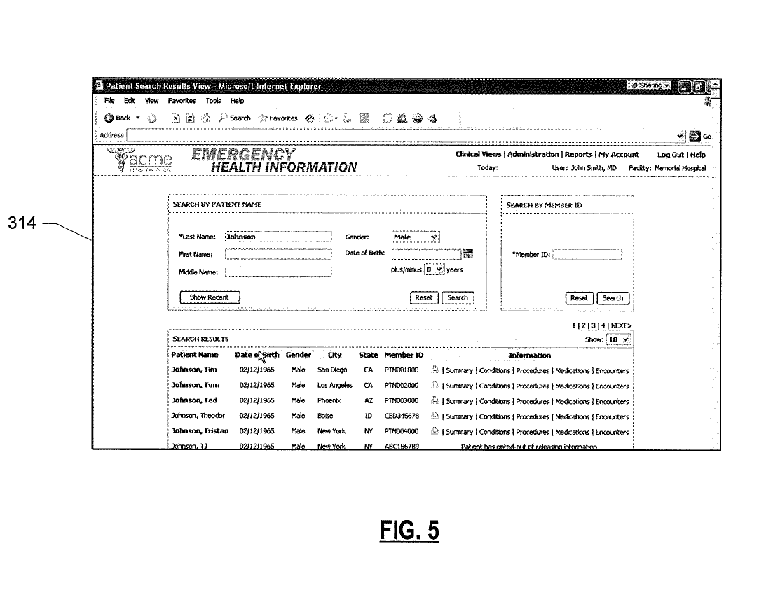

A search may generally result in a list of search results, which may be presented in tabular form. A user may select certain fields to display as a result of a patient search, as well as the order of the fields. FIG. 5 shows an example of search results 314 generated by a computer program product in accordance with one embodiment of the present invention. As shown in the figure, a default configuration may include the following fields: “Name”, “Date of Birth”, “Identification Number”, (patient's) “City”, and (patient's) “State”. In one embodiment, the total number of results from the patient search may be presented up to a certain maximum so as to reduce the effect of a search on performance, and, in certain instances, to prevent a user from “database fishing” (i.e., generating an overly broad search in order to view large populations of patients). In order to better manage the results of a patient search, each column, which may represent a particular field, may be sorted and inversely sorted. The patient search may also include links that direct a user to various clinical views, as will be discussed below. In various embodiments, the present invention may support the ability to allow data owners to control access to their data. In one embodiment, this control may operate as an opt-out system. Another embodiment may require consent for access to the data. Because some of the data contained in an IEHR in such an embodiment may require patient consent for access (in addition to, or irrespective of, any other security authorization), certain clinical views may query a user as to whether patient consent has been obtained. If the user indicates that patient consent has been obtained, the clinical view may be displayed for the user. If the user indicates that patient consent has not been obtained, the clinical view may not be displayed for the user. In certain circumstances, for example where patient consent may not be readily obtained but where access to the clinical view is necessary for patient care, the user may be able to indicate so and then access the clinical view.

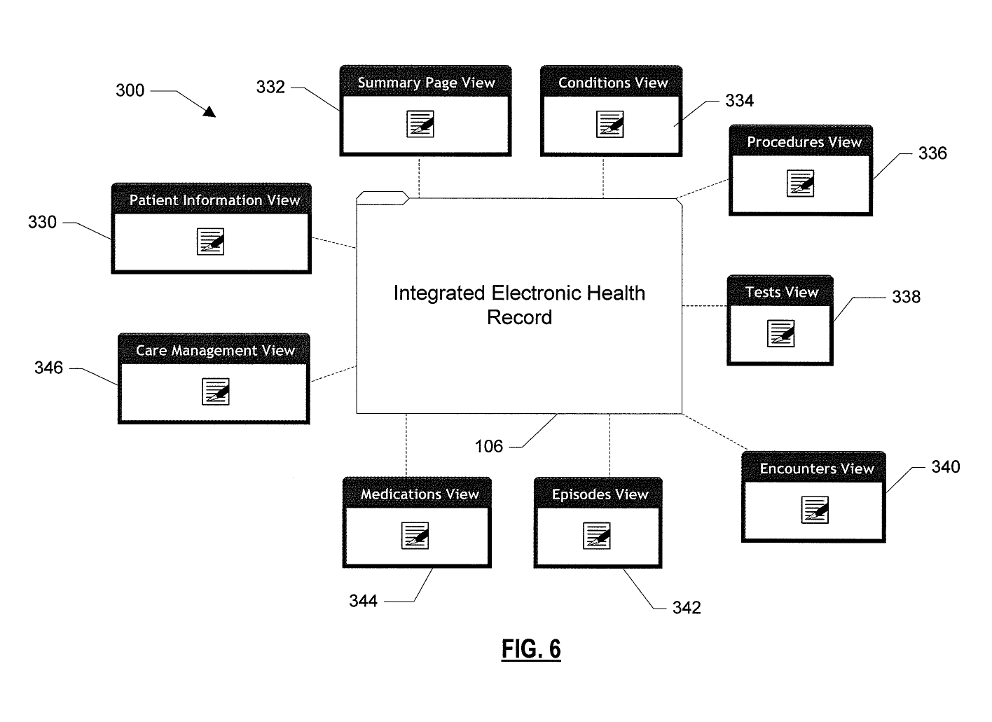

FIG. 6 shows the clinical views 300 available in a patient's IEHR 100 according to one exemplary embodiment of the present invention. In general, it should be noted that the type of clinical views 300 available and the data presented in the clinical views 300 may be customized by a user based on the user's needs. In the exemplary embodiment of the present invention, basic patient identifying information may be shown as a header on all pages of a clinical view 300. For example, a clinical view header may include a patient's name, gender, date of birth, identification number, phone number and address. It should also be noted that for each clinical view 300, a user may have the ability to receive additional data by selecting linkable data contained on each clinical view 300, as well as sort and/or filter any data contained in the clinical view 300. Additionally, a user may be able to print from the clinical (and detailed) views. The data included in the printout may also be customized by the user. Additionally, a customizable summary may be printed. This summary allows a user to choose information from any clinical or detailed view to include in the summary printout. Disclaimers and/or any other information desired by a user may also be included in any printout.

In various embodiments, the clinical views 300 may contain sensitive data, which may include sensitive claims data and/or sensitive disease management data, and thus the clinical views 300 may be subject to security authorization before each page of a clinical view 300 is displayed. In this manner, it may be determined whether a particular user has the rights to access the sensitive data contained on any particular page of a clinical view 300. Additionally, a user may have the ability to identify specific codes or ranges of codes associated with particular data that the user desires not to be displayed. Users may also have the ability to identify specific codes or code ranges that may require additional security authorization in order to be displayed. For example, these codes may represent a mental heath group, a reproductive group, certain procedures, certain medications, etc. For each clinical view, a variety of detailed views may be displayed. The detailed views may present additional data (or the same or other data) corresponding to the respective clinical view in a variety of useful ways.

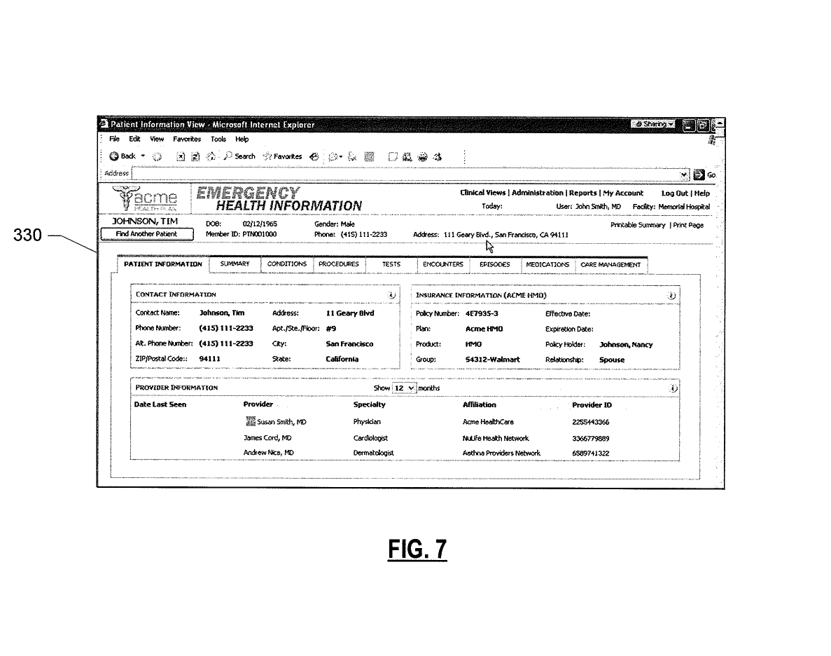

One clinical view 300 in an exemplary embodiment of the present invention is a patient information view 330. FIG. 7 shows an example of a patient information view 330 generated by a computer program product in accordance with one embodiment of the present invention. The patient information view 330 may include the following sections: “Contact Information”, “Insurance Information”, and “Provider Information”. The “Contact Information” section may include the patient's name, address, and phone numbers. The “Insurance Information” section may include any insurance plan, product, and group and corresponding information associated with the patient. The “Insurance Information” section may also include any insurance policy numbers, enrollment dates, and termination dates. The names of the holders of the insurance policies may also be provided, along with their relationship with the patient. The “Providers” section of the patient information view 330 may include the name, specialty, affiliation, address, phone number for a primary care physician and for any healthcare providers associated with the patient. The information may also include any dates the patient had an encounter with the provider, including specifically highlighting the last date the patient had an encounter with the provider. The “Providers” section may also include the date that the patient was last seen at a particular provider.

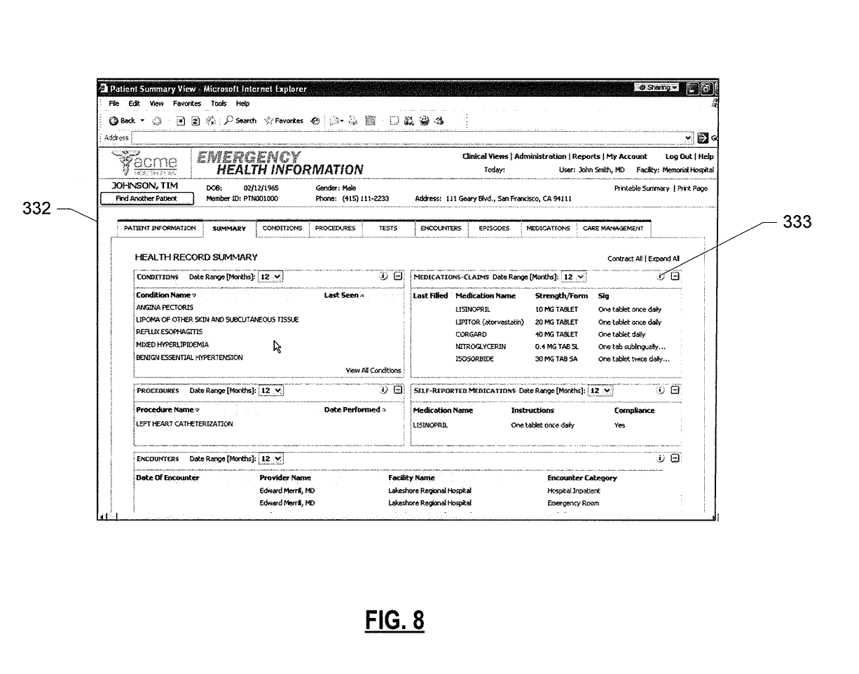

Another clinical view 300 in an exemplary embodiment of the present invention is a summary page view 332. In various embodiments, the summary page view 332 may be configured according to the needs of a user. FIG. 8 shows an example of a summary page view 332 generated by a computer program product in accordance with one embodiment of the present invention. In the depicted embodiment, the summary page view 332 may include the following sections: “Conditions”, “Procedures”, “Medications” (including self-reported medications), and “Encounters”. The “Conditions” section of the summary page 332 may include the names of any diagnoses and any dates relating to any diagnoses associated with the patient. The “Procedures” section of the summary page view 332 may include any procedures associated with the patient, and the dates of those procedures. With regard to the “Procedures” section of the summary page view 332, in some embodiments a user may desire to exclude non-clinically meaningful procedures from the summary page view 332. Such non-clinically meaningful procedures may include venipuncture (common blood draw), etc. The “Medications” section of the summary page view 332 may also include the names of any medication prescriptions filled by the patient, the strength and form of each medication, the sig code associated with each medication, the quantity and days supplied for each medication, and any refills associated with each medication. As shown in the figure, self-reported medications may also be included. The self-reported medications may include the name of any medications reported by the patient, instructions relating to taking the medication, and whether the patient has been compliant with these instructions. The “Encounters” section of the summary page view 332 may include the date, provider name, and location for any encounters with the patient. Although not visible in the figure, the summary page view 332 of the depicted embodiment also includes “Tests” and “Care Management” sections. As noted above, the summary page view 332 may be configured by a user and may include groupings or other arrangements of the data. It should also be noted that the clinical and detailed views may provide information that extends beyond the size of a computer screen. Therefore, although various figures appended to this application may not show all of the information available in a particular clinical or detailed view, additional information may be provided and may be accessed by scrolling to the additional information, as is common in various graphical user interfaces.

Various embodiments of the present invention may also provide a user with the date that data was added to and/or updated in the IEHR, thus giving the user an indication of the relative “freshness” of the data included in various clinical and detailed views. For example, a graphical user interface icon 333 may be included for one or more sections of a clinical or detailed view. Activating the icon 333 (such as by clicking the icon or positioning a graphical user interface pointer near the icon) may provide the user with the date that the associated data was added to the IEHR. In the depicted embodiment, positioning a graphical user interface pointer near the icon 333 activates an indication that shows the user the date that the data in that particular section was last updated. Clicking on the icon 333 activates a new detailed view that summarizes a history of all of the data updates for that particular section.

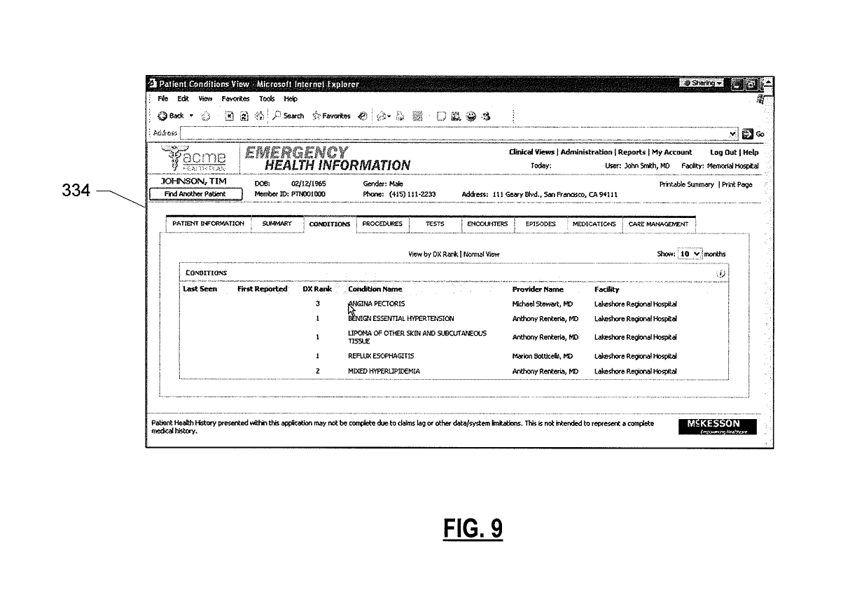

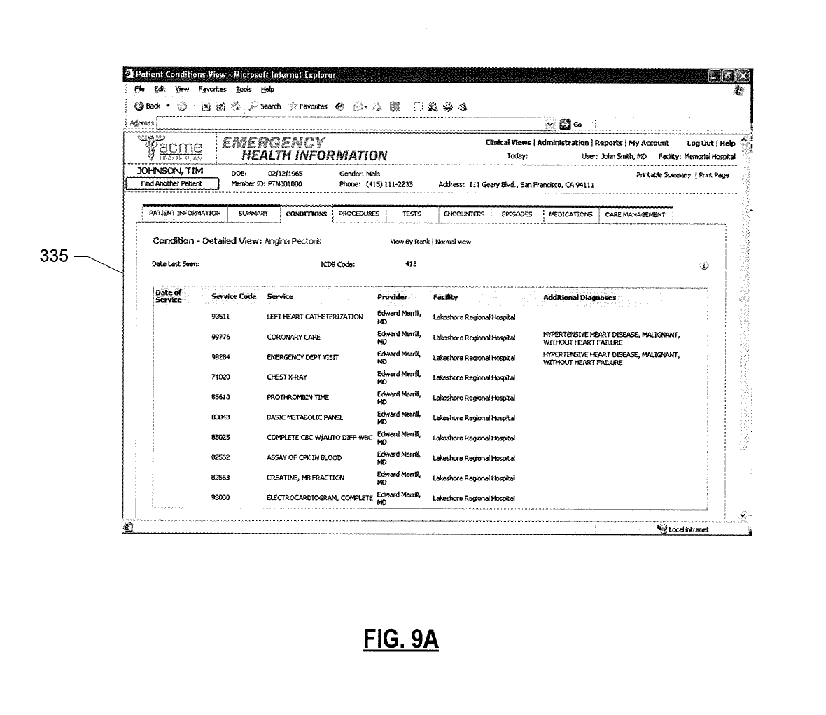

Another clinical view 300 in one exemplary embodiment of the present invention is a conditions view 334. FIG. 9 shows an example of a conditions view 334 generated by a computer program product in accordance with one embodiment of the present invention. The conditions view 334 may include a list of distinct diagnoses associated with the patient, along with the dates of the diagnoses, the dates the patient was last seen, the names of the providers where the diagnoses were made, and the locations of the providers who made the diagnoses. Additional information relating to the diagnoses may also be included, such as the International Statistical Classification of Diseases and Related Health Problems code (commonly and hereinafter referred to as the “ICD code”) relating to each diagnoses. The information may also include a DX rank for each diagnoses, which may rank diagnoses such as primary diagnoses, secondary diagnoses, tertiary diagnoses, etc. This clinical view may also allow the user to display details relating to any specific diagnoses, including disease management data, such as evidence-based medical information, medical literature, analytic and predictive modeling tools, treatment algorithms, etc. As noted above, clinical views may also be displayed in a variety of detailed views. An exemplary conditions detailed view is provided in FIG. 9A. In the depicted embodiment, the conditions detailed view combines all claims related to a given condition and presents services associated with that condition. The conditions detailed view also allows grouping by the rank of the diagnosis so that a user can view the services that were performed when the condition was the primary or first diagnosis on the claim versus if it were the second or third.

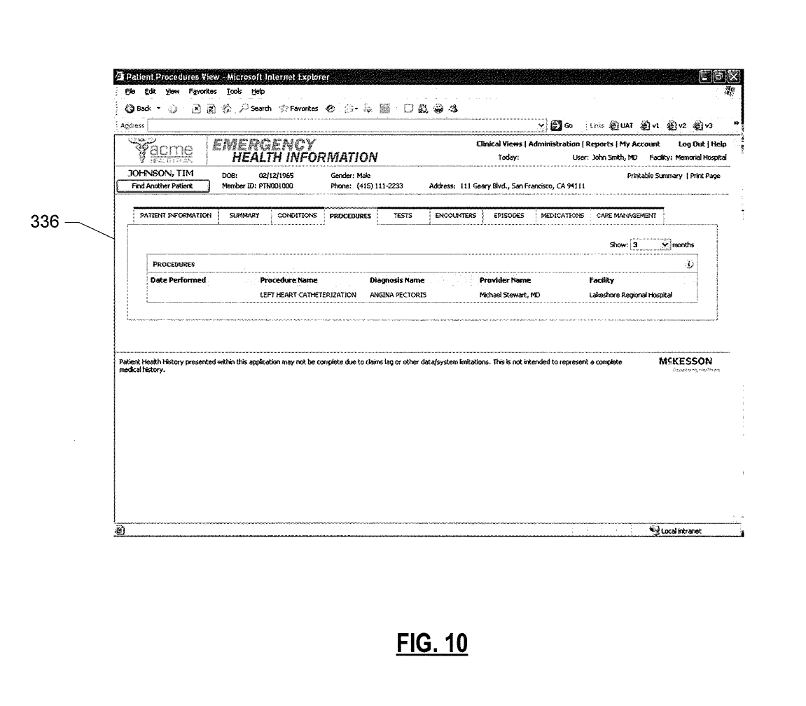

Another clinical view 300 in one exemplary embodiment of the present invention is a procedures view 336. FIG. 10 shows an example of a procedures view 336 generated by a computer program product in accordance with one embodiment of the present invention. The procedures view 336 may indicate any procedure descriptions associated with the patient. This view may also include the provider name, location, and diagnoses related to each procedure. In various embodiments, an user may choose to exclude certain standard procedures from this view.

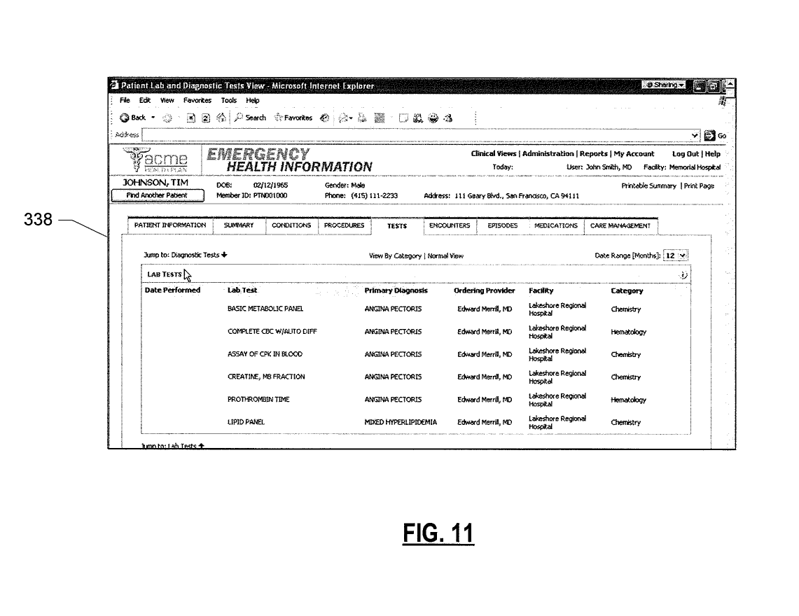

Another clinical view 300 in one exemplary embodiment of the present invention is a tests view 338. FIG. 11 shows an example of a tests view 338 generated by a computer program product in accordance with one embodiment of the present invention. The tests view 338 may include the names of any diagnostic tests and lab tests performed on the patient, as well as the corresponding date, CPT code, location, provider of the diagnostic and lab tests, and test category. This view may also include any diagnoses relating to the diagnostic and lab tests. In various detailed views, tests may be grouped by test category. Exemplary lab test categories may include, but are not limited to, chemistry tests and hematology tests.

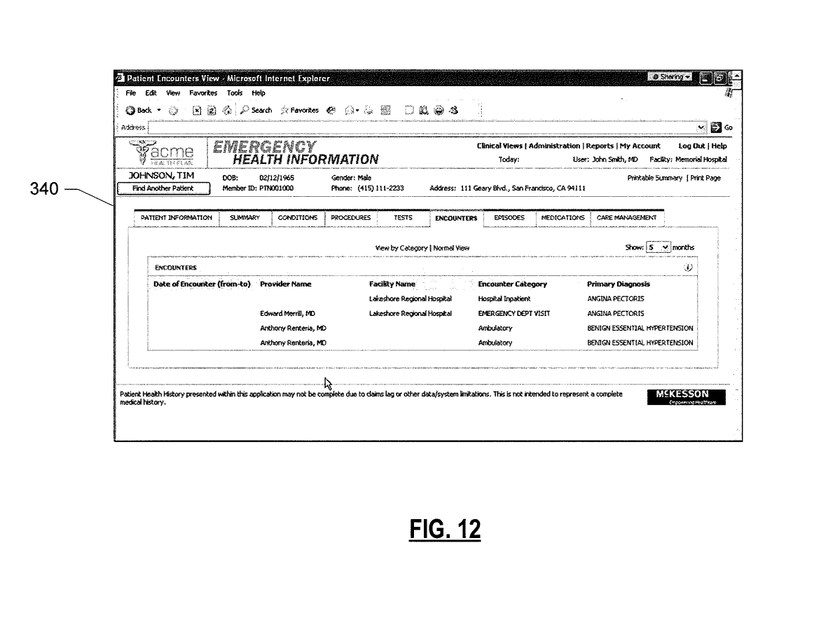

Another clinical view 300 in one exemplary embodiment of the present invention is an encounters view 340. FIG. 12 shows an example of an encounters view 340 generated by a computer program product in accordance with one embodiment of the present invention. The encounters view 340 may include the date, provider name, facility location, and encounter category. This view may also include any diagnoses relating to the encounters. In various detailed views, encounters may be grouped by encounter categories. Exemplary encounter categories include, but are not limited to, hospital inpatient encounters, emergency department visit encounters, and ambulatory encounters.

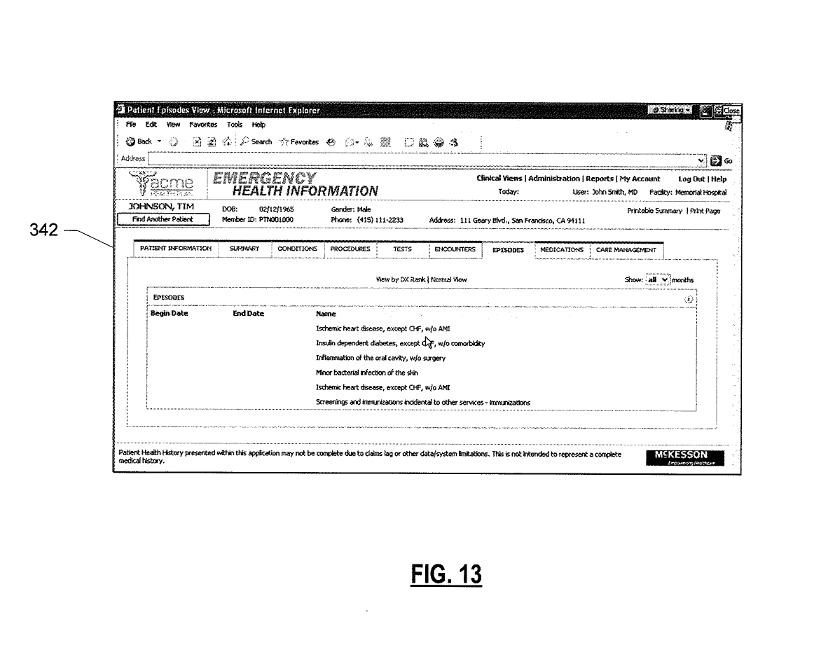

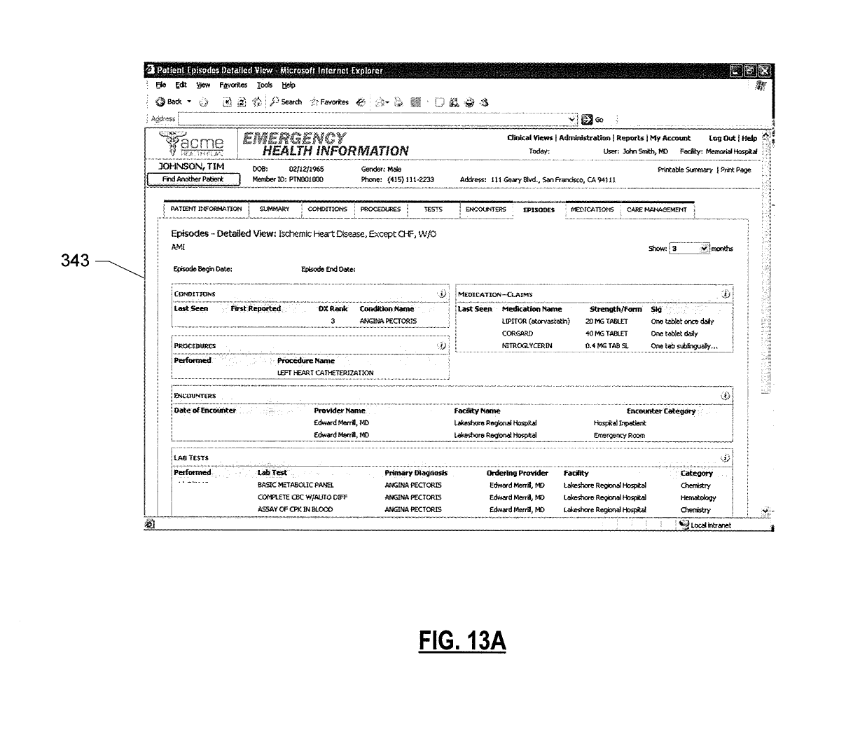

Another clinical view 300 in one exemplary embodiment of the present invention is an episodes view 342. FIG. 13 shows an example of an episodes view 342 generated by a computer program product in accordance with one embodiment of the present invention. The episodes view 342 may include the date and name of any episodes relating to the patient. An user may also customize this view by providing an episode key and description that will tie applicable claims together into an episode. As noted above, clinical views may also be displayed in a variety of detailed views. An exemplary episodes detailed view is provided in FIG. 13A. The episodes detailed view provides a summary view of all of the clinically important information obtained from claims for that particular episode of care.

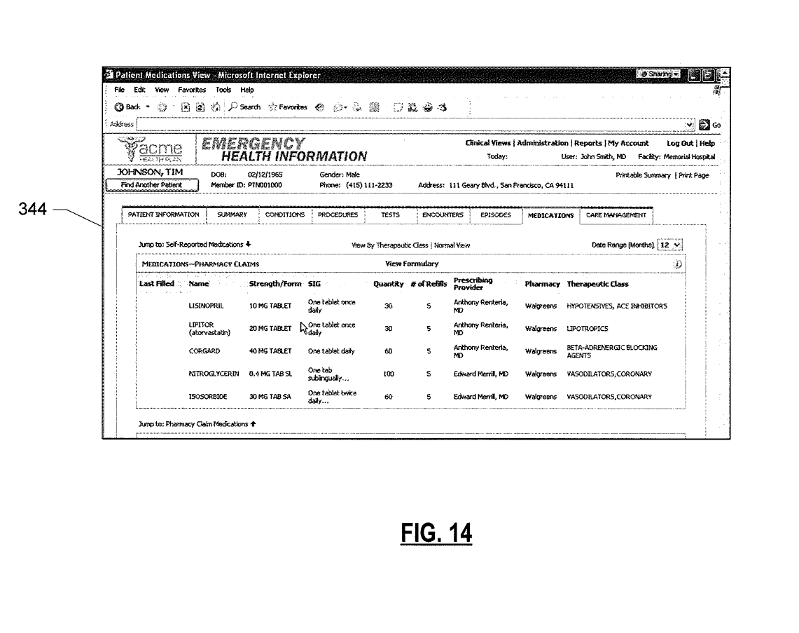

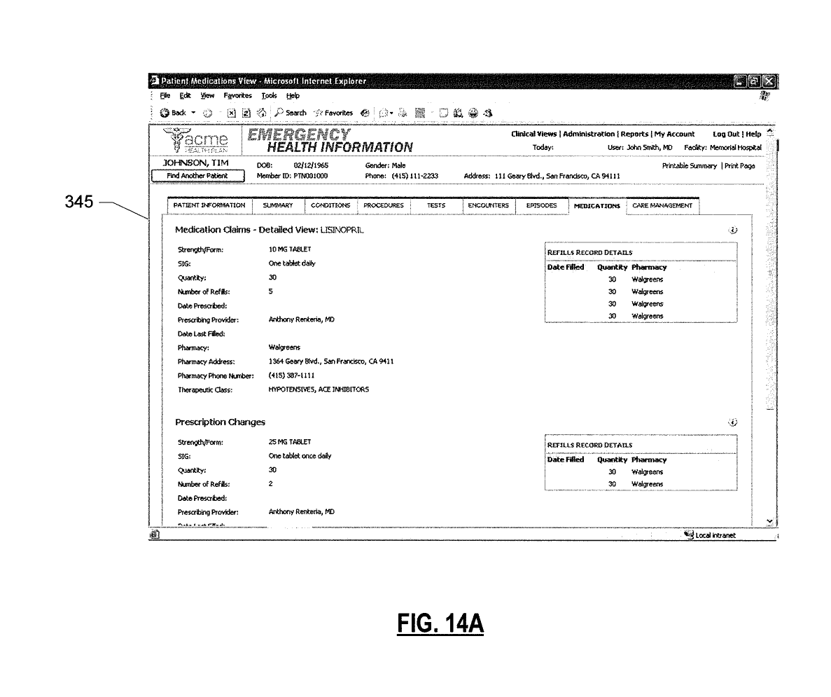

Another clinical view 300 in one exemplary embodiment of the present invention is a medications view 344. FIG. 14 shows an example of a medications view 344 generated by a computer program product in accordance with one embodiment of the present invention. The medications view 344 may include both data provided in the claims data 102 (see FIG. 1), as well as data self-reported by the patient. In the depicted embodiment of the medications view 344, the data provided in the claims data 102 may include the name of each medication filled by the patient, as well as the strength/form of the medication, and the sig description, quantity, refill information, date prescribed, prescribing physician, generic name, the date last filled associated with the medication, and a therapeutic class associated with the medication. The medications view 344 may also include data about each medication from the disease management data 104. With regard to self-reported information, the medications view 344 may include the name, and instructions for any other medication not included in the claims data 102. Additionally, the self reported information may include data from the patient relating to medicine compliance, and/or reasons for medicine non-compliance. In various embodiments, an user may have the ability to group and display medications by therapeutic class. Additionally, the medications view 344 may include a link to a payor's list of preferred pharmaceutical products, or formulary, to be used by a payor's network physicians. As noted above, clinical views may also be displayed in a variety of detailed views. An exemplary medications detailed view is provided in FIG. 14A. The medications detailed view allows a user to view all of the prescriptions that were filled for a given medication as well as all of the refills for that particular medication. The example in FIG.14A shows two prescriptions for the medication Lisinopril. One prescription having had four refills and the other having had two refills.

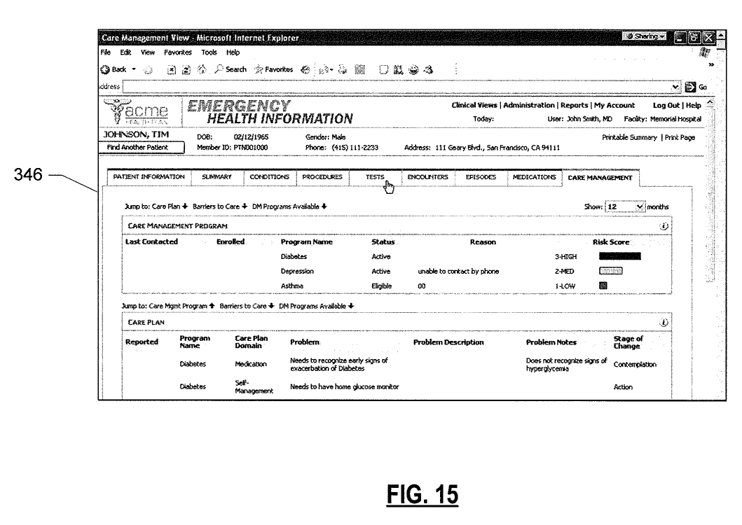

Finally, another clinical view 300 in one exemplary embodiment of the present invention is a care management view 346. FIG. 15 shows an example of a care management view 346 generated by a computer program product in accordance with one embodiment of the present invention. In the exemplary embodiment, the care management view 346 may include the names of any programs in which the patient is enrolled, the date of enrollment, the status of the patient in that program, and the program contact information. The care management view 346 may also include a care plan that includes a problem list showing the names of the problems associated with the patient, descriptions of the problems, and notes relating to the problems. The care management view 346 may also include disease management data as described above. This view may also show barriers to care, comorbidities, self reported laboratory work, and other disease management information.

Although not shown in the figures, it should be noted that other embodiments of the present invention may include additional clinical views, such as a lab orders view, a lab results view, an allergies view, a clinical and/or encounter documentation view, an alerts view, an advanced directives view and a case management view.

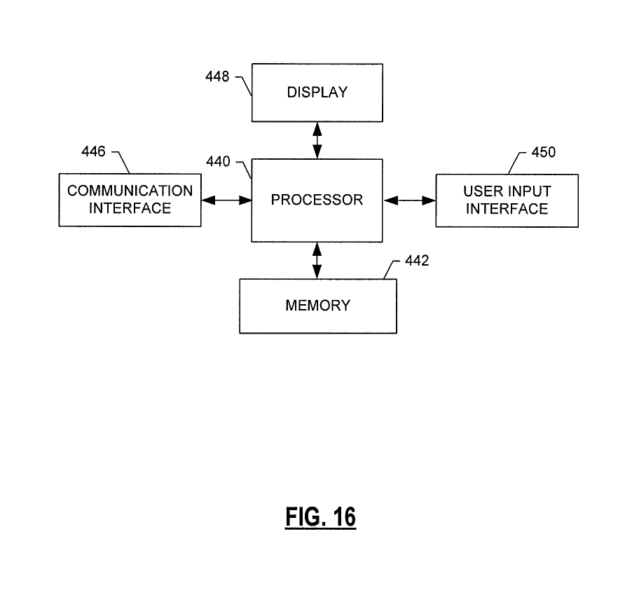

The foregoing merely illustrates how exemplary embodiments of the present invention generate an IEHR by combining claims data with disease management data. Referring now to FIG. 16, a block diagram of an exemplary electronic device (e.g., PC, laptop, PDA, etc.) configured to execute the method of generating an IEHR of exemplary embodiments of the present invention is shown. The electronic device may include various means for performing one or more functions in accordance with exemplary embodiments of the present invention, including those more particularly shown and described herein. It should be understood, however, that the electronic device may include alternative means for performing one or more like functions, without departing from the spirit and scope of the present invention. As shown, the electronic device may generally include means, such as a processor, controller, or the like 440 connected to a memory 442, for performing or controlling the various functions of the entity.

The memory can comprise volatile and/or non-volatile memory, and typically stores content, data or the like. For example, the memory typically stores content transmitted from, and/or received by, the electronic device. Also for example, the memory typically stores software applications, instructions or the like for the processor to perform steps associated with operation of the electronic device in accordance with embodiments of the present invention. In particular, the memory 442 may store computer program code for an application and other computer programs. For example, in one exemplary embodiment of the present invention, the memory may store computer program code for, among other things, receiving claims data and disease management data, wherein receiving the claims data comprises receiving claims data selected from the group consisting of medical claims data and pharmacy claims data, processing the claims data and the disease management data, wherein processing the claims data and the disease management data comprises associating the claims data and the disease management data, populating a common electronic health record using the claims data and the disease management data, and displaying the common electronic health record in at least one clinical view, wherein displaying the common electronic health record in at least one clinical view comprises presenting at least a portion of the claims data or disease management data in an interactive form.

In addition to the memory 442, the processor 440 can also be connected to at least one interface or other means for displaying, transmitting and/or receiving data, content or the like. In this regard, the interface(s) can include at least one communication interface 446 or other means for transmitting and/or receiving data, content or the like, as well as at least one user interface that can include a display 448 and/or a user input interface 450. The user input interface, in turn, can comprise any of a number of devices allowing the electronic device to receive data from a user, such as a keypad, a touch display, a joystick or other input device.

As described above and as will be appreciated by one skilled in the art, embodiments of the present invention may be configured as a method and apparatus. Accordingly, embodiments of the present invention may be comprised of various means including entirely of hardware, entirely of software, or any combination of software and hardware. Furthermore, embodiments of the present invention may take the form of a computer program product consisting of a computer-readable storage medium (e.g., the memory 442 of FIG. 16) and computer-readable program instructions (e.g., computer software) stored in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

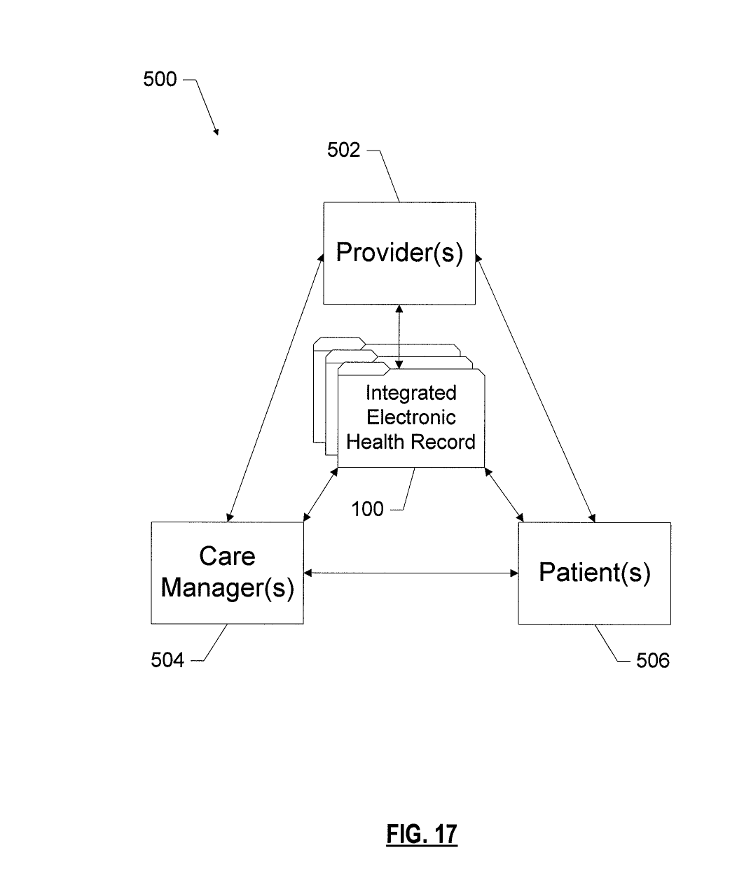

FIG. 17 shows another embodiment of the present invention in which a collaborative environment 500 is created incorporating integrated electronic health records 100 and is shared among different types of users, which may include, but are not limited to, provider users, care manager users, and patient users,. The collaborative environment 500 may be embodied in a variety of forms, including, but not limited to, a medical management platform operating between one or more parties, such as providers 502, payor care managers 504, and patients 506. The collaborative environment 500 provides two-way communication of information among the parties, allowing sharing of information, including information contained in one or more integrated electronic health records 100. In one embodiment, this sharing comprises one or more provider users reviewing care plan problems in the care management view, that review comprising one or more of the following: indicating agreement or disagreement with one or more of the care plan problems, prioritizing one or more of the care plan problems, adding a comment to one or more of the care plan problems, or adding one or more new care plan problems. In another embodiment, a message and/or alert containing information that a change has been made by a provider to the care plan is sent to one or more care managers associated with the patient.

In various embodiments, the environment 500 may allow patient status and other relevant care data to be uploaded by each of the parties. This may also include an integrated care management plan whereby a patient's care plan may be presented to the parties who may then have the ability to comment, prioritize/re-prioritize, add a new care plan item, edit existing care plan items, etc. The environment 500 may also include a messaging and alert system whereby important information is presented to the appropriate party. Another aspect of the collaborative environment 500 is the ability of a party to upload data into customized clinical views. In this manner, the parties may apply different rules to the data to determine which portions of the data to display in various views, while maintaining the ability to share data.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of generating an integrated electronic health record, said method comprising:
receiving claims data and disease management data, wherein receiving claims data comprises receiving claims data selected from the group consisting of medical claims data and pharmacy claims data;
storing the claims data and the disease management data;
processing the claims data and the disease management data, wherein processing the claims data and the disease management data comprises associating the claims data and the disease management data;
populating a common electronic health record with the claims data and disease management data; and
displaying the common electronic health record in at least one clinical view, wherein displaying the common electronic health record in at least one clinical view comprises presenting at least a portion of the claims data or disease management data in an interactive form.

2. The method of claim 1, wherein at least one detailed view is associated with the clinical view.

3. The method of claim 1, wherein the at least one clinical view is selected from the group consisting of a patient information view, a summary page view, a conditions view, a procedures view, a tests view, an encounters view, an episodes view, a medications view, and a care management view.

4. The method of claim 3, wherein at least one clinical view is a conditions view, and wherein at least one detailed view is associated with the conditions view, the at least one detailed view combining claims data related to a given condition and presenting services associated with that condition, the conditions detailed view also being configured to allow grouping by a rank of diagnoses.

5. The method of claim 3, wherein at least one clinical view is an episodes view, and wherein at least one detailed view is associated with the episodes view, the at least one detailed view providing summary data obtained from claims data for a given episode.

6. The method of claim 5, wherein the summary data is selected from the group consisting of data relating to conditions associated with the given episode, procedures associated with the given episode, tests associated with the given episode, encounters associated with the given episode, medications associated with the given episode, and disease management data associated with the given episode.

7. The method of claim 3, wherein at least one clinical view is a medications view, and wherein at least one detailed view is associated with the medications view, the at least one detailed view configured to allow a user to view prescriptions that were filled for a given medication.

8. The method of claim 7, wherein the medications view comprises at least one therapeutic class categorization for the given medication.

9. The method of claim 7, wherein the medications view is configured to provide a link to a payor's formulary.

10. The method of claim 1, wherein the clinical view is configured to select and aggregate diagnoses into a summary.

11. The method of claim 1, wherein the at least one clinical view is configured to detail services for a specific condition, the services selected from the group consisting of encounters, procedures, lab tests, and diagnostic tests.

12. The method of claim 1, wherein the at least one clinical view is configured to separate services into procedures, lab tests, diagnostic tests, and encounters.

13. The method of claim 1, wherein the at least one clinical view is configured to categorize lab tests, diagnostic tests, and encounters.

14. The method of claim 1, wherein the at least one clinical view is configured to aggregate claims data at a medication level.

15. The method of claim 1, wherein displaying the common electronic health record further comprises displaying a customized clinical view including presenting at least a portion of the claims data or disease management data in a customized form.

16. The method of claim 1, wherein displaying the common electronic health record in at least one clinical view comprises applying a series of rules to the claims data and the disease management data to determine which portions of the claims data and the disease management data to display in the clinical view.

17. The method of claim 16, wherein applying the series of rules comprises grouping the claims data and the disease management data into one or more categories.

18. The method of claim 17, wherein grouping the claims data and the disease management data into one or more categories comprises determining if the claims data or the disease management data contains sensitive data, and if so, grouping sensitive claims data, sensitive disease management data, and any other sensitive data into a category containing sensitive data.

19. The method of claim 18, wherein displaying a clinical view comprises requiring a predefined security authorization prior to including the sensitive data in the clinical view.

20. The method of claim 1, further comprising accessing the integrated electronic health record through a web browser.

21. A computer program product for generating an integrated electronic health record, wherein the computer program product comprises at least one computer-readable storage medium having computer-readable program code portions stored therein, the computer-readable program code portions comprising:
a first executable portion for receiving claims data, wherein receiving claims data comprises receiving claims data selected from the group consisting of medical claims data and pharmacy claims data;
a second executable portion for receiving disease management data;
a third executable portion for storing the claims data and the disease management data;
a fourth executable portion for processing the claims data and the disease management data, wherein processing the claims data and the disease management data comprises associating the claims data and the diseased management data;
a fifth executable portion for populating a common electronic health record with the claims data and disease management data; and
a sixth executable portion for displaying the common electronic health record in at least one clinical view, wherein displaying the common electronic health record in at least one clinical view comprises presenting at least a portion of the claims data or disease management data in an interactive form.

22. The computer program product of claim 21, wherein at least one detailed view is associated with the clinical view.

23. The computer program product of claim 21, wherein the at least one clinical view is selected from the group consisting of a patient information view, a summary page view, a conditions view, a procedures view, a tests view, an encounters view, an episodes view, a medications view, and a care management view.

24. The computer program product of claim 23, wherein at least one clinical view is a conditions view, and further comprising a seventh executable portion for generating at least one detailed view associated with the conditions view, the at least one detailed view combining claims data related to a given condition and presenting services associated with that condition, the conditions detailed view also being configured to allow grouping by a rank of diagnoses.

25. The computer program product of claim 23, wherein at least one clinical view is an episodes view, and further comprising a seventh executable portion for generating at least one detailed view associated with the episodes view, the at least one detailed view providing summary data obtained from claims data for a given episode.

26. The computer program product of claim 25, wherein the summary data is selected from the group consisting of data relating to conditions associated with the given episode, procedures associated with the given episode, tests associated with the given episode, encounters associated with the given episode, medications associated with the given episode, and disease management data associated with the given episode.

27. The computer program product of claim 23, wherein at least one clinical view is a medications view, and further comprising a seventh executable portion for generating at least one detailed view associated with the medications view, the at least one detailed view configured to allow a user to view prescriptions that were filled for a given medication.

28. The computer program product of claim 27, wherein the medications view comprises at least one therapeutic class categorization for the given medication.

29. The computer program product of claim 27, wherein the medications view is configured to provide a link to a payor's formulary.

30. The computer program product of claim 21, wherein the clinical view is configured to select and aggregate diagnoses into a summary.

31. The computer program product of claim 21, wherein the at least one clinical view is configured to detail services for a specific condition, the services selected from the group consisting of encounters, procedures, lab tests, and diagnostic tests.

32. The computer program product of claim 21, wherein the at least one clinical view is configured to separate services into procedures, lab tests, diagnostic tests, and encounters.

33. The computer program product of claim 21, wherein the at least one clinical view is configured to categorize lab tests, diagnostic tests, and encounters.

34. The computer program product of claim 21, wherein the at least one clinical view is configured to aggregate claims data at a medication level.

35. The computer program product of claim 21, wherein said sixth executable portion comprises displaying the common electronic health record in a customized clinical view including presenting at least a portion of the claims data or disease management data in a customized form.

36. The computer program product of claim 21, wherein said sixth executable portion comprises applying a series of rules to the claims data and the disease management data to determine which portions of the claims data and the disease management data to display in the clinical view.

37. The computer program product of claim 36, wherein applying the series of rules comprises grouping the claims data and the disease management data into one or more categories.

38. The computer program product of claim 37, wherein grouping the claims data and the disease management data into one or more categories comprises determining if the claims data or the disease management data contains sensitive data, and grouping sensitive claims data, sensitive disease management data, and any other sensitive data into a category containing sensitive data.

39. The computer program product of claim 38, wherein displaying a clinical view comprises requiring a predefined security authorization prior to including the sensitive data in the clinical view.

40. The computer program product of claim 21, further comprising accessing the integrated electronic health record through a web browser.

41. An apparatus for generating an integrated electronic health record, said apparatus comprising:
an input element for receiving claims data and disease management data, wherein receiving claims data comprises receiving claims data selected from the group consisting of medical claims data and pharmacy claims data;
a processor in communication with the input element; and
a memory in communication with the processor, said memory storing an application executable by the processor, said application configured, upon execution, to store the claims data and the disease management data, and to process the claims data and the disease management data, wherein processing the claims data and the disease management data comprises associating the claims data and the disease management data, to populate a common electronic health record using the claims data and disease management data, and to display the common electronic health record in at least one clinical view, wherein displaying the common electronic health record in at least one clinical view comprises presenting at least a portion of the claims data or disease management data in an interactive form.

42. The apparatus of claim 41, wherein at least one detailed view is associated with the clinical view.

43. The apparatus of claim 41, wherein the at least one clinical view is selected from the group consisting of a patient information view, a summary page view, a conditions view, a procedures view, a tests view, an encounters view, an episodes view, a medications view, and a care management view.

44. The apparatus of claim 43, wherein at least one clinical view is a conditions view, and wherein at least one detailed view is associated with the conditions view, the at least one detailed view combining claims data related to a given condition and presenting services associated with that condition, the conditions detailed view also being configured to allow grouping by a rank of diagnoses.

45. The apparatus of claim 43, wherein at least one clinical view is an episodes view, and wherein at least one detailed view is associated with the episodes view, the at least one detailed view providing summary data obtained from claims data for a given episode.

46. The apparatus of claim 45, wherein the summary data is selected from the group consisting of data relating to conditions associated with the given episode, procedures associated with the given episode, test associated with the given episode, encounters associated with the given episode, medications associated with the given episode, and disease management data associated with the given episode.

47. The apparatus of claim 43, wherein at least one clinical view is a medications view, and wherein at least one detailed view is associated with the medications view, the at least one detailed view configured to allow a user to view prescriptions that were filled for a given medication.

48. The apparatus of claim 47, wherein the medications view comprises at least one therapeutic class categorization for the given medication.

49. The apparatus of claim 47, wherein the medications view is configured to provide a link to a payor's formulary.

50. The apparatus of claim 41, wherein the clinical view is configured to select and aggregate diagnoses into a summary.

51. The apparatus of claim 41, wherein the at least one clinical view is configured to detail services for a specific condition, the services selected from the group consisting of encounters, procedures, lab tests, and diagnostic tests.

52. The apparatus of claim 41, wherein the at least one clinical view is configured to separate services into procedures, lab tests, diagnostic tests, and encounters.

53. The apparatus of claim 51, wherein the at least one clinical view is configured to categorize lab tests, diagnostic tests, and encounters.

54. The apparatus of claim 51, wherein the at least one clinical view is configured to aggregate claims data at a medication level.

55. The apparatus of claim 41, wherein displaying the common electronic health record comprises displaying a customized clinical view including presenting at least a portion of the claims data or disease management data in a customized form.

56. The apparatus of claim 41, wherein said application applies a series of rules to the claims data and the disease management data and determines which portions of the claims data and the disease management data to display in the clinical view.

57. The apparatus of claim 56, wherein applying the series of rules comprises grouping the claims data and the disease management data into categories.

58. The apparatus of claim 57, wherein grouping the claims data and the disease management data into categories comprises determining if the claims data or the disease management data contains sensitive data, and grouping sensitive claims data, sensitive disease management data, and any other sensitive data into a category containing sensitive data.

59. The apparatus of claim 58, wherein displaying a clinical view comprises requiring a predefined security authorization prior to including the sensitive data in the clinical view.

60. The apparatus of claim 41 wherein the integrated electronic health record is accessible through a web browser.

61. A method of providing a collaborative medical management environment among two or more users, comprising:
providing at least one integrated electronic health record, the integrated electronic health record comprising an aggregation of claims data and disease management data;
providing users with access to the integrated electronic health records; and
providing two-way communication among the users, allowing sharing of information among the users.

62. The method of claim 61, wherein the users are selected from the group consisting of provider users, care manager users, and patient users.

63. The method of claim 62, wherein the integrated electronic health record includes at least a care management clinical view comprising a patient care plan that includes a problem list, and wherein the sharing of information comprises one or more provider users reviewing care plan problems.

64. The method of claim 63, wherein reviewing care plan problems is selected from the group consisting of indicating agreement or disagreement with one or more care plan problems, prioritizing one or more of the care plan problems, adding a comment to one or more of the care plan problems, and adding one or more new care plan problems.

65. The method of claim 63, wherein at least one of a message or an alert is sent to one or more care manager users, the message or alert containing information that a change to the care plan has been made by a provider user.
